(19) United States
(12) Patent Application Publication
(10) Pub. No.: US 2009/0272923 A1
(43) Pub. Date: Nov. 5, 2009

(54) Adaptable safety nipple for nursing infants

(76) Inventor: Michael Eugene Franklin, Little Elm, TX (US)

Correspondence Address: David E. Orr, 4616 NE 134th Street, Vancouver, WA, 98686, US

(21) Appl. No.: 12/150,989

(22) Filed: May 1, 2008

(51) Int. Cl. F16K 31/00; A61J 9/00

(52) U.S. Cl. 251/61.1; 215/11.4

(57) ABSTRACT

The invention is disclosed as a nipple having a detachable coupler. In a first exemplary form the coupler the coupler is made to receive the nipple and to make a seal at the portion of the nipple abutting the coupler. The seal is made to prevent loss of fluid at the juncture or interface where the nipple meets the coupler. In the first exemplary form, the coupler has threads, which permit the coupler to be screwed onto a bottle having threads around the opening of the bottle. Fluid passes from the bottle into the coupler, through the coupler into the nipple and from the interior of the nipple into the baby's mouth. In a second exemplary form of the coupler, the coupler has an elastic opening to permit the coupler to be stretched over the opening of a fluid container. In the exemplary embodiments the interior of the nipple has a valve, through which all fluid must pass before exiting the nipple and entering the baby's mouth. The valve is made to limit the flow of fluids from the fluid container. When the flow rate is exceeded, the valve closes to prevent the maximum flow rate to be exceeded.

### RELATED APPLICATIONS

None

### FIELD

The present invention is related to the field of infant feeding devices; more specifically the present invention is a nipple having a safety valve to prevent the infant from receiving too much fluid during feeding by a bottle or fluid container. The nipple comprises an adapter that permits the nipple to be connected to a wide variety of containers.

### OBJECTS AND ADVANTAGES

It is therefore as a first object and advantage of the present invention of the present invention an adaptable nursing device having a replaceable nipple with a safety valve to prevent excessive fluids from being ingested by a baby, infant or child nursing from a nipple.

A second object and advantage is a nipple having a replaceable coupler so that a nipple may be attached to a variety of fluid containers.

And another object is a nursing device having a nipple that may be replaced.

Other benefits and advantages of the invention will appear from the disclosure to follow. In the disclosure reference is made to the accompanying drawings, which form a part hereof and in which is shown by way of illustration an exemplary embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

In a first embodiment disclosed below, the invention is disclosed as nursing device having a detachable coupler for receiving a nipple. The detachable coupler may be made in several forms.

The device may be used by an infant or child up to and including the age of six. In the following narrative, the term “baby” will be used for infants or children.

In a first exemplary form the coupler is made to receive the nipple and to make a seal at the portion of the nipple abutting the coupler. The seal is made to prevent loss of fluid at the juncture or interface where the nipple meets the coupler. In the first exemplary form, the coupler has threads, which permit the coupler to be screwed onto a bottle having threads around the opening of the bottle. Fluid passes from the bottle into the coupler, through the coupler into the nipple and from the interior of the nipple into the baby's mouth.

In a second exemplary form the coupler the coupler is also made to receive the nipple and to make a seal at the portion of the nipple abutting the coupler. In the second exemplary form of the coupler, the coupler has an elastic opening to permit the coupler to be stretched over the opening of a fluid container. Fluid passes from the bottle into the coupler, through the coupler into the nipple and from the interior of the nipple into the baby's mouth.

In both embodiments, the interior of the nipple is furnished with a valve, through which all fluid must pass before exiting the nipple and entering the baby's mouth. The valve is made to limit the flow of fluids from the fluid container. When the flow rate is exceeded, the valve closes to prevent the maximum flow rate to be exceeded.

The fluid restriction valve has the general form of a cylinder made to fit into the fluid receiving opening of the nipple; that is the opening opposite the fluid dispensing opening received into baby's mouth. The cylinder comprises a first valve part, a second valve part and a third valve part.

The first valve part is made as a flat inflexible disk having a hole in the center through which all fluid must pass before being dispensed by the nipple. The first valve part is also made with a plurality of channels that are situated along the radii of the hole outside the circumference of the hole. The channels convey fluid from outside the circumference of the hole and into the hole. The channels receive fluid from the second valve part, restricted by the third valve part and are made so that fluid may only flow into and out of the hole in the first valve part.

The second valve part is made as a flat inflexible disk having circular recess, the circular recess made larger than the hole made in the first valve part. A hole is made though the second valve part. The hole in the second valve is made to be slightly larger than the hole made in the first valve part. However, the hole in the second valve part does not encompass the full extent of any of the channels made in the first valve part.

The third valve part is a flexible disk configured to be accommodated within the circular recess of the second valve part. The diameter of the third valve part is slightly larger than the hole made in the second valve part. The thickness of the third valve part is such that it may be received into the recess of the second valve part and is held between the first valve part and the second valve part.

The first valve part and the second valve part are fastened together entrapping the third valve part in the recess of the second valve part.

In operation, fluid flows from the container and into the hole made in the second valve part. Fluid flows onto the flexible disk of the third valve part and into the channels of the first valve part, and then flows through the channels into the hole made in the first valve part. Fluid then flows into the nipple and into baby's mouth.

As long as fluid flow is not excessive, the flexible disk is not distended. However, when flow is excessive, the flexible disk is distended into the hole made in the first valve part, partially blocking flow from the channels made in the first valve part.

A more detailed description will be given below with reference made to the accompanying drawings.

### BRIEF DESCRIPTION OF DRAWINGS

FIG. 1 shows a first embodiment of the coupler, wherein the first embodiment is made to screw the coupler with restriction valve onto a bottle made with threads.

FIG. 2A shows the second embodiment of the coupler, wherein the coupler receives the restriction valve, is made to be elastic, and to fit over the opening of a container and to be held in place by elastic forces.

FIG. 2B shows the adapter configured to receive a different type of nipple.

FIG. 3A1 shows the first part of the restriction valve.

FIG. 3A2 shows the reverse side of the first part of the restriction valve.

FIG. 3B shows the second part of the restriction valve.

FIG. 3C shows the third part of the restriction valve.

FIG. 3D shows the restriction valve assembled.

FIG. 4A shows the restriction valve in operation with normal fluid flow.

FIG. 4B shows the restriction valve in operation with excessive fluid flow.

### DETAILED DESCRIPTIONS

### Exemplary Embodiments of the Invention

With reference to the accompanying drawings, two exemplary embodiments are disclosed. A first exemplary embodiment comprises a coupler for receiving a nipple and for providing a restriction valve for restricting fluid flow into the nipple. The first embodiment coupler is screwed onto a fluid container having threads. The second exemplary embodiment also comprises a coupler for receiving a nipple and for providing a restriction valve for restricting fluid flow into the nipple. The second embodiment coupler is stretched over the opening of a container and the coupler and the restriction valve are held by elastic forces.

The nipple received and held may be orthodontic, angled or vented. In an orthodontic nipple the bulb, the part of the nipple the baby sucks on, is flattened to resemble the shape of the mother's nipple during breastfeeding. Because of its shape, this type of nipple sometimes sticks shut after feedings, making it difficult to clean. In an angled nipple, the nipple leans to one side so that it automatically tilts into your baby's mouth. In a vented nipple a small hole in the neck of the nipple lets air into the bottle while keeping liquid in. This prevents the nipple from collapsing. While vents help the nipple stay erect, most babies instinctively suck just fine without them by opening their mouth and letting air back into the bottle.

### A First Exemplary Embodiment of the Coupler

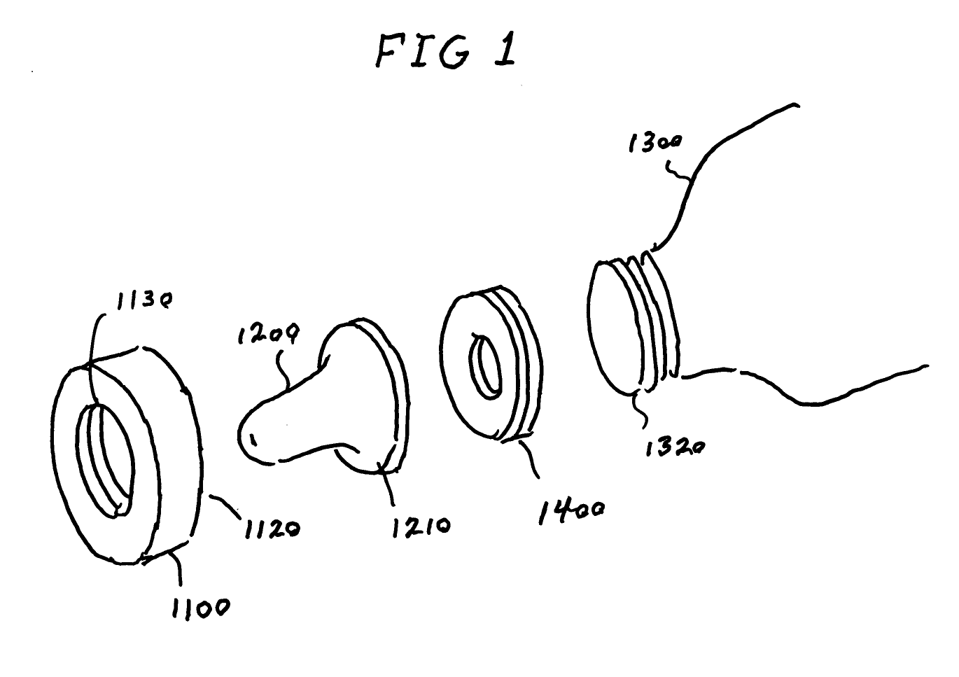

With reference to FIG. 1, the coupler in the general shape of a hollow cylinder 1100 having a first opening 1110 and a second opening 1120. The cylinder 1100 has threads 1130 within which are made to engage the threads 1310 of a container 1300, whereby the coupler may be screwed down tight onto the container 1300.

Again with reference to FIG. 1, the first opening 1110 of the coupler is made smaller than the second opening 1120. A nipple 1200 is inserted into the second opening 1120 and through the first opening to protrude through the first opening 1110. The flange 1210 of the nipple is held within the second opening 1120 and, by being larger than the first opening 1110 is held within the hollow cylinder 1100 of the coupler. When the coupler is screwed onto a container 1300, the flange of the nipple 1210 is trapped between the periphery of the second opening 1120 and top 1320 of the container 1300.

The restriction valve 1400 is made to fit within the first opening 1110 and into the nipple 1200 and to be trapped and held within the nipple 1200 by the top 1320 of the container 1300.

### A Second Exemplary Embodiment of the Coupler

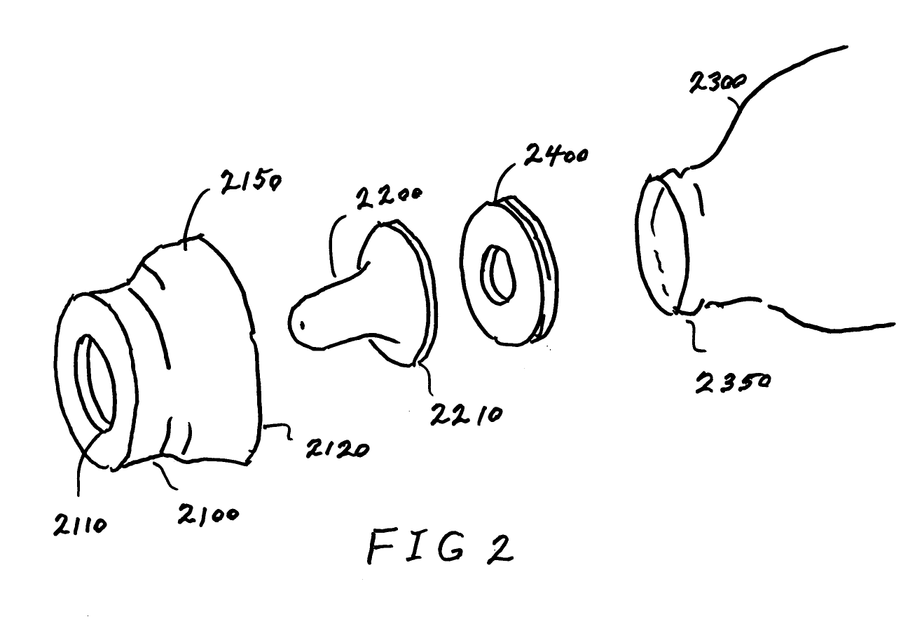

With reference to FIG. 2A, the coupler comprises hollow cylinder 2100 having a first opening 2110 and a second opening 2120. The cylinder 2100 has an elastic enclosure 2150 made to fit over the mouth 2350 of a container 2300, whereby the coupler may be held by the elastic forces of the enclosure 2150 onto the mouth 2350 of the container 2300.

The restriction valve comprises a first valve part, a second valve part and a third valve part.

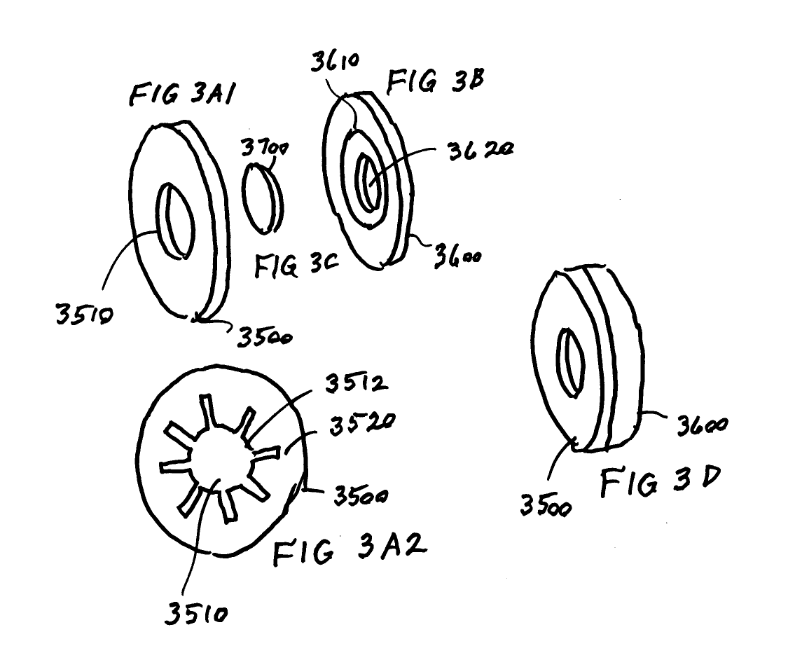

With reference to FIG. 3A1 the first valve part is made as a flat inflexible disk 3500 having a hole 3510 in the center through which all fluid must pass before being dispensed by the nipple. With reference to FIG. 3A2 (the reverse side of the part shown in FIG. 3A1) the first valve part is also made with a plurality of channels 3520 that are situated along the radii of the hole outside the circumference 3512 of the hole. The channels 3520 convey fluid from outside the circumference of the hole 3512 and into the hole 3510. The channels 3520 are made so that fluid may only flow into and out of the hole 3510 in the first valve part.

With reference to FIG. 3B the second valve part is made as a flat inflexible disk 3600 having circular recess 3610, the circular recess 3610 made larger than the hole made in the first valve part (see 3510 of FIG. 3A). A hole 3620is made though the second valve part. The hole 3620 in the second valve is made to be slightly larger than the hole made in the first valve part (see 3510 of FIG. 3A). However, the hole 3620 in the second valve part does not encompass the full extent of any of the channels made in the first valve part (see 3520 of FIG. 3A).

With reference to FIG. 3C the third valve part is a flexible disk 3700 configured to be accommodated within the circular recess of the second valve part (see 3610 of FIG. 3B). The diameter of the third valve part 3700 is slightly larger than the hole made in the second valve part (see 3620 of FIG. 3B). The thickness of the third valve part 3700 is such that it may be received into the recess of the second valve part and is held between the first valve part and the second valve part. The shape of the third valve part 3700 is concave with respect to the first valve part shown in FIG. 3A1.

With reference to FIG. 3D the first valve part 3500 and the second valve part 3600 are fastened together entrapping the third valve part 3700 (not shown in FIG. 3D) in the recess 3610 of the second valve part.

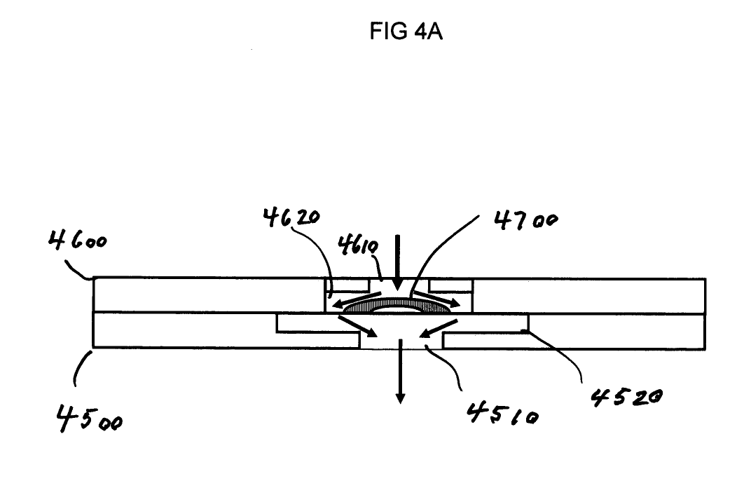

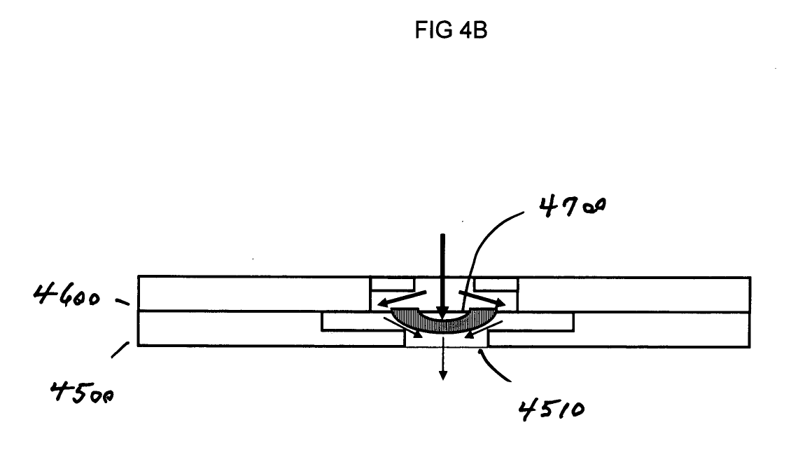

With reference to FIG. 4A in operation, fluid flows from the container and into the hole 4720 made in the second valve part. Fluid flows onto the flexible disk of the third valve part 4700 and into the channels 4520 of the first valve part, and then flows through the channels 4520 into the hole 4510 made in the first valve part. Fluid then flows into the nipple and into baby's mouth.

With reference to FIG. 4A as long as fluid flow is not excessive, the flexible disk 4700 is not distended. However, with reference to FIG. 4B when flow is excessive, the flexible disk 4700 is distended into the hole 4510 made in the first valve part, partially blocking flow from the channels 4510 made in the first valve part, thereby limiting flow into the nipple and into baby's mouth.

### DISCLOSURE SUMMARY

The present invention has been disclosed in two exemplary embodiments, each having a valve for restricting fluid flow to a nursing baby. It will be appreciated that other embodiments and variations of the invention may be inferred from the disclosure made herein, therefore the scope and limitations of the present invention are defined by the claims that follow.

I claim:

1. A valve for an infant's nipple attached to a bottle, the valve configured to be received inside the nipple, the valve comprising:
a first element made to seal the nipple against flow into the flow, the first element having a first recess into which fluid flows from the bottle;
second element abutting the first element, the second element having a second recess smaller than the first recess, the second recess made with a plurality of channels radiating from the second recess, and;
a diaphragm received into the first recess;
whereby fluid flows around the diaphragm into the channels and through the second recess into the nipple until increasing pressure forces the diaphragm into the second recess causing flow into the channels to decrease.
